(19) United States
(12) Patent Application Publication
(10) Pub. No.: US 2009/0030753 A1
(43) Pub. Date: Jan. 29, 2009

(54) Anomaly Aggregation method

(75) Inventors: Deniz Senturk-Doganaksoy, Danbury, CT (US); Christina A. LaComb, Schenectady, NY (US); Richard J. Rucigay, Saratoga Springs, NY (US); Peter T. Skowronek, Marietta, GA (US); Andrew J. Travaly, Ballston Spa, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/881,612

(22) Filed: Jul. 27, 2007

(51) Int. Cl. G06F 9/44

(52) U.S. Cl. 705/7

(57) ABSTRACT

A method for aggregating anomalous values is provided. The method comprises obtaining operational data from at least one machine and calculating at least one exceptional anomaly score from the operational data. The exceptional anomaly scores can then be aggregated to identify acute or chronic anomalous values.

### BACKGROUND OF THE INVENTION

The present invention is related to the following application Ser. No. ______, titled “Fleet Anomaly Detection Method” and filed on ______.

The systems and methods described herein relate generally to aggregating anomalous values. More specifically, the systems and methods relate to statistical techniques to aggregate outlying (i.e., anomalous) engineering or operational data when compared to small sets of related engineering or operational data.

In the operation and maintenance of power generation equipment (e.g., turbines, compressors, generators, etc.), sensor readings corresponding to various attributes of the machine are received and stored. These sensor readings are often called “tags”, and there are many types of tags (e.g., vibration tags, efficiency tags, temperature tags, pressure tags, etc.).

Close monitoring of these tags across time has many benefits in understanding machine deterioration characteristics (e.g., internal damage to units, compressor events, planned vs. unplanned trips). For example, increasing values (over time) of rotor vibration in a compressor, may be an indication of a serious problem. Better knowledge of deterioration in machines also improves fault diagnostic capability via a set of built-in rules or alerts that act as leading indicators for machine events. Simultaneous display of all tag anomalies together with the designed rules-alerts makes machine monitoring and diagnostics, as well as, new rule/alert creation, extremely efficient, and effective. Individuals responsible for monitoring and diagnostics can have their immediate attention directed to critical deviations.

However, there is a considerable amount of noise in sensor data. To remove noise and make observations comparable across time or across machines, many different corrections need to be made and many different controlling factors need to be used. Even then, it is still very hard to simultaneously monitor many tags (there can be several hundred to thousands of tags) and diagnose the anomalies in the data.

Removing the noise from data and catching or identifying anomalies in a usable format (e.g., magnitude and direction) and then using that anomaly information in rule or model building is a needed process in many different businesses, technologies and fields. In engineering applications, monitoring and diagnostic teams typically address the problem in routine and ad-hoc fashion via control charts, histograms, and scatter plots. However, this approach necessitates a subjective assessment as to whether a given tag is anomalously high or low.

There are known statistical techniques including z-scores to evaluate the degree to which a particular value in a group is an outlier, that is, anomalous. Typical z-scores are based upon a calculation of the mean and the standard deviation of a group. While a z-score can be effective in evaluating the degree to which a single observation is anomalous in a well populated group, z-scores have been shown to lose their effectiveness as an indication of anomalousness when used on sets of data that contain only a small number of values.

When calculating anomaly scores, it is often the case that there are only a few values with which to work. For instance, when comparing a machine (e.g., a turbine) to a set of peer machines (e.g., similar turbines), it is often the case that it is difficult to identify more than a handful of machines that can legitimately be considered peers of the target machine. In addition, it is often desirable to evaluate the performance of machines that may only have been in operation under the current configuration for a limited period of time. As a result, it is often not desirable or accurate to use standard z-scores as a measurement for anomaly scores since standard z-scores are not robust with small datasets.

Accordingly, a need exists in the art for a process, method and/or tool that can easily identify, quantify, aggregate and display anomalies experienced by various types of power generation equipment. Also, this process, method and/or tool should allow anomaly information to be turned into meaningful knowledge such as leading indicators to events of interest.

### BRIEF DESCRIPTION OF THE INVENTION

A method for identifying an anomalous value is provided. The method comprises obtaining operational data from at least one machine and calculating at least one exceptional anomaly score from the operational data. The exceptional anomaly scores can then be aggregated to identify anomalous values.

A method for aggregating anomalous values is provided. The method comprises obtaining operational data from at least one machine, and calculating at least one exceptional anomaly score from the operational data. The exceptional anomaly scores can be aggregated by calculating at least one magnitude anomaly measure. The magnitude anomaly measure identifies the average value of the exceptional anomaly scores over a predetermined period of time. The exceptional anomaly scores can also be aggregated by calculating at least one frequency anomaly measure. The frequency anomaly measure indicates a percentage of any predetermined period of time having anomalous values.

### BRIEF DESCRIPTION OF THE DRAWINGS

FIG. 1 is an exceptional anomaly score cutoff table.

FIG. 2 illustrates the exceptional anomaly score descriptive statistics.

FIG. 3 is a graph illustrating the conversion between the cut off values and the anomaly distribution percentages based on the empirical results for the Z-Withins.

FIG. 4 illustrates the distribution of the Z-Within values.

FIG. 5 illustrates the distribution of the Z-Between values.

FIG. 6 illustrates the value of Z-Within over time for two separate machines.

FIG. 7 illustrates the value of Z-Within over time for thirty-one separate machines.

FIG. 8 illustrates the values of the daily absolute average and percent anomaly values over time.

FIG. 9 illustrates a graph of a set of data of maximum percentile Z-Betweens and maximum percentile Z-Withins.

FIG. 10 illustrates a table of the daily magnitude and frequency anomaly scores and daily percentiles for Z-Betweens and Z-Withins.

FIG. 11 illustrates a heatmap comprised of a plurality of rows and columns. The columns of the heatmap represent time periods and the rows represent metrics of interest, such as vibration and performance measures.

FIG. 12 illustrates another heatmap that provides a snapshot of an example machine over a 24-hour period.

### DETAILED DESCRIPTION OF THE INVENTION

In monitoring and diagnostics (M&D), eliminating noise from data is a key concept. It becomes non-trivial when there are a lot of variables that need to be monitored simultaneously per second and even more so when condition adjustment (e.g., temperature, operating mode, pressure, etc.) is required. An anomaly detection and aggregation process and heatmap tool is herein described that is highly useful and revolutionary for monitoring and diagnostics. The process, method and tool, as embodied by the present invention, is particularly useful when applied to power generation equipment, such as, compressors, generators and turbines. However, the process, method and tool can be applied to any machine or system that needs to be monitored. For example, other machines that can be used with the present invention are gas turbines, hydroelectric turbines, steam turbines, bio-fueled turbines, wind turbines, engines, gensets, and locomotives. The process, method and tool comprises five main features:

(1) Calculating exceptional anomaly scores (EAS) for engineering data, (e.g., operational sensor data). Exceptional anomaly scores quantify outlying data when compared to small sets of related data. EAS outperforms Z-score and control chart statistics in identifying anomalous observations.

(2) Creating multiple sensitivity settings for the exceptional anomaly scores so that users can define which percentage of the data they can effectively and efficiently monitor across a given set of tags and time points. Moreover, these different sensitivity settings can be used to add diagnostics, (e.g., alert creation).

(3) Providing methodologies for aggregating various anomalous observations at different data granularities, (e.g., hourly vs. daily anomalous observations). These different anomalous observations can be interlinked and transferable to one another. An anomalous hourly observation may propagate up to a daily anomalous observation.

(4) Creating alerts. These alerts are rule-based triggers that may be defined by the end-user or provided based on analytical means to identify events (e.g., compressor events) with lead-time. Alerts are based on exceptional anomaly scores and raw sensor data. Alerts may also make use of sensitivity setting adjustments and aggregation properties of exceptional anomaly scores.

(5) Creating heatmaps that turn data into knowledge. A heatmap is an outlier-detection-visualization tool that can be performed on each specified machine unit for a large number of selected tags across many different time points. A heatmap illustrates the anomaly-intensity and the direction of a ‘target observation.’ A heatmap may also contain a visual illustration of alerts, and directs immediate attention to hot-spot sensor values for a given machine. Heatmaps can also provide comparison to peers analysis, which allows the operational team to identify leaders and lagers, as well as marketing opportunities on the fly with great accuracy across different time scales (e.g., per second, minute, hour, day, etc.).

Calculating Exceptional Anomaly Scores

In order to account for unit/machine and environmental variations and determine whether or not a given value for a tag for a target unit is outside an expected range (i.e., anomalous), context information may be used to form a basis for the analysis of the target unit's tag data. This context information can be taken from two primary sources: the target unit's past performance, and the performance of the target unit's peers. By using such context information to quantify the typical amount of variation present within the group or within the unit's own performance, it is possible to systematically and rigorously compare current tag data to context data and accurately assess the level of anomalous data in the target unit's tag values.

As noted above, context information is used to properly evaluate the degree to which a given tag is anomalous. In order to have an effective evaluation, the context data must be properly selected. When selecting the appropriate context data over the time domain, it is generally desirable to look at the closest data available to the time period of interest. Since the time period of interest is usually the most recent data available, the appropriate scope of time to consider is a sequence of the most recent data available for the unit—for example, the data corresponding to the last two calendar weeks. This mitigates the influence of seasonal factors.

Proper context data to take into account the behavior of the group and overall environment is found by using an appropriate group of ‘peer’ units to the target unit. For example, a group of turbines with the same frame-size and within the same geographic region are selected to act as the appropriate peer group for the target turbine.

In addition to the context considerations stated above, context data also includes comparable operating conditions. For this implementation, and as one example only, comparable operating conditions can be defined to mean any time period in the past where the unit has the same OPMODE, DWATT and CTIM values within a window of 10. OPMODE can be defined as the operation mode (e.g., slow cranking, peak output, 50% output, etc.). DWATT can be a metric for power (e.g., megawatt output). CTIM can be defined as a temperature metric (e.g., inlet temperature). For example, if the target observation's value of OPMODE is equal to 1 and DWATT is equal to 95, only the historical periods where OPMODE=1 and DWATT was between 90 and 100 could be used. These comparable operating conditions are defined as part of the system configuration.

By establishing the appropriate context, both in time, geography, frame size, and operating conditions, the need for a subjective assessment as to whether a given tag is anomalously high or low can be avoided, and objective and automatic calculations can be made to detect and quantify anomalies. To calculate the Z-Within (comparison to past) exceptional anomaly scores, we can use 10-15 historical observations where the unit was operating under comparable conditions (as defined above). These historical observations can be used to calculate an average and standard deviation. The z-score can then be calculated of the target observation using the historical observations' average and standard deviation. The minimum and maximum number of observations used for the calculation of Z-Within exceptional anomaly score is defined as part of the system configuration. Z-Within provides a comparison of a specific machine's current operating condition to the machine's prior operating condition. The equation used to calculate Z-Within may be generally of the form:

$$Z - {Within}_{exceptional} = ( \frac{{Value}_{Target} - {Average}_{Historical}}{{StandardDeviation}_{Historical}} ) \qquad ( Equation 1 )$$

For each unit, up to 8 or more other units with the same frame-size with similar configurations and in the same geographic region can be identified as peers. The Z-Between exceptional anomaly score is an indication of how different a specific unit or machine is from its peers. For example, an F-frame gas turbine compared to other similar F-frame gas turbines. To calculate the Z-Between exceptional anomaly scores (comparison to peers), one can select the single most-recent observation from each of the peers where the peer is operating under comparable condition (as defined above). This results in up to 8 or more peer observations with which to calculate an average and standard deviation. The z-score of the target unit using the peer group's average and standard deviation can then be calculated. The minimum and maximum number of observations used for the calculation of Z-Between exceptional anomaly score is defined as part of the system configuration. The equation used to calculate Z-Between may be generally of the form:

$$Z - {Between}_{exceptional} = ( \frac{{Value}_{Target} - {Average}_{Peers}}{{StandardDeviation}_{Peers}} ) \qquad ( Equation 2 )$$

Note that it is the case that a value can be either anomalously high, or anomalously low. While there generally is a particular direction that is recognized as being the preferable trend in a value (e.g., it is generally better to have low vibrations than high vibrations), it should be noted that this technique is designed to identify and quantify anomalies regardless of their polarity. In this implementation, the direction does not indicate the “goodness” or “badness” of the value. Instead, it represents the direction of the anomaly. If the exceptional anomaly score is a high negative number compared to the past, it means the value is unusually low compared to the unit's past. If the exceptional anomaly score is a high positive number, it means the value is unusually high compared to the unit's past. The interpretation is similar for peer anomaly scores. The anomaly direction of the individual tags can be defined as part of the system configuration.

By using these techniques to detect anomalies, alerts can be created. An alert can be a rule-based combination of tag values against customizable thresholds.

Creating Multiple Sensitivity Settings

For exceptional anomaly scores, a conversion between the scores and the percent tail calculations can be performed. Specifically, a range of magnitudes of exceptional anomaly scores will correspond to a range of percentages of the anomaly distribution given the distribution of the raw metric. Via this conversion, an analyst can pick the exceptional anomaly score cut off values that indicate ‘alarms’ or ‘red flags’ for the raw metrics. In addition, it provides an ease of use for the end-user who can freely decide what percentage is high enough to be named as an ‘anomaly.’ Moreover, via this conversion the ‘anomaly’ definition can be easily changed from application to application, business to business or metric to metric as needed.

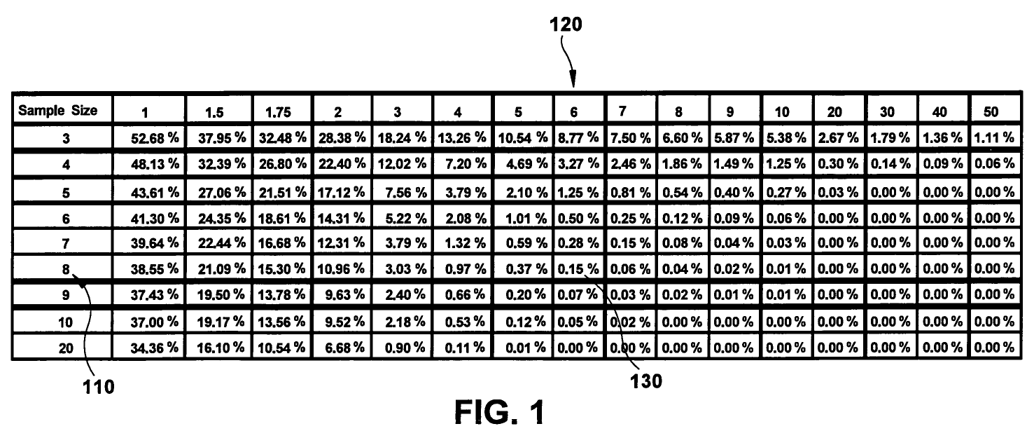

FIG. 1 (Exceptional Anomaly Score Cutoff Table) is a conversion table that may be used when the raw metric is normally distributed and the anomaly definition is two-tailed (i.e., both high and low magnitudes of the raw metric would have anomalous ranges that the end-user cares about). For example, when the sample size is 8 (row 110) and the raw metric is assumed to be normally distributed, 0.15% (cell 130) of the cases are expected to fall below an exceptional anomaly score of −6 and above 6 (column 120). In other words, if the M&D team is willing to investigate the top 0.15% observations as ‘out of norm’ within a metric, then they should pick 6 as the score cut off given that their sample size is 8 and normality is assumed. This table also illustrates the relationship between the z-scores and exceptional anomaly scores. As the sample size increases and when normality is assumed, z-scores and exceptional anomaly scores become almost identical.

For example, in a turbine or compressor the sensor data may comprise over 300 different tags with many different shapes of distributions. A sensitivity analysis is needed to see whether the same cut off values can be used across tags or whether different cut off values are needed for different tags. In other words, how robust the conversion tables are across different distributions needs to be tested given the high dimensional sensor data. Although different tags may exhibit different shapes and scales of distributions, the Z-Within and Z-Between scores on those tags may have less variety in shape and by design in scale. Across all the Z-Within and Z-Between distributions, there have been detected natural cutoffs at exceptional anomaly scores of 2, 6, 17, 50 and 150. However, an additional systematic empirical study to determine the cut offs and the corresponding anomaly distribution percentages needs to be conducted.

The exceptional anomaly scores are categorized into 11 buckets (i.e., (−2, 2)=bucket0, (2, 6)=bucket1, (6, 17)=bucket2, (17, 50)=bucket3, (50, 150)=bucket4, (150 and up)=bucket5, (−6, −2)=bucket-1, (−17, −6)=bucket-2, (−50, −17)=bucket-3, (−150, −50)=bucket-4, (−150 and below)=bucket-5). The percent of Z-Within scores falling into each bucket for every tag are calculated. Then, the distribution is drawn of those percentages across tags for each bucket and the quartiles are calculated as well as the 95% confidence interval for the median.

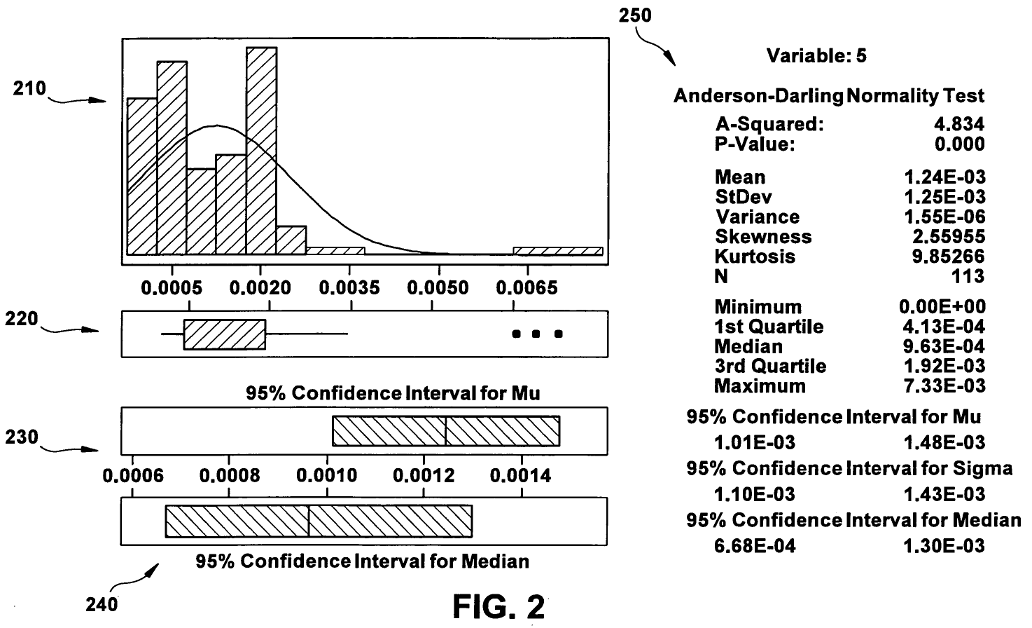

FIG. 2 illustrates the anomaly score descriptive statistics and is an example of these calculations on bucket5. Region 210 is a histogram and shows the distribution of the probability or percentage values. These are the probabilities of getting an anomaly score at or above 150 cut off for Z-Withins. Region 220 is a boxplot which again shows the distributions of the probability or percentage values for an anomaly score being at or above 150. 230 illustrates the 95% confidence interval for the distribution mean of the probability or percentage values. The vertical line in the box represents the mean value and the limits of the box represent the minimum and the maximum values for the confidence interval. Another boxplot is indicated at 240 and this illustrates the 95% confidence interval for the distribution median of the probability or percentage values. The line in this box represents the median value and the limits of box represent the minimum and the maximum values for the confidence interval. The statistics listed in region 250 represent a normality test for the illustrated distribution, the basic statistics such as the mean and the median and the confidence intervals for the basic stats that are reported. The median for the bucket5 distribution is approximately 0.1%, indicating that approximately 0.1% of the Z-Within Scores are at or above 150 cutoff. 95% confidence interval for the median is 0.07%-1.3%.

Calculations are performed similar to the ones in FIG. 2 for all buckets separately, thus for all cut off values for Z-Withins and Z-Betweens. The results of the analysis indicate that similar cut offs across tags can be used for the given sensor data and thus the conversion tables as well as the preset cut offs are robust to raw tag distribution differences.

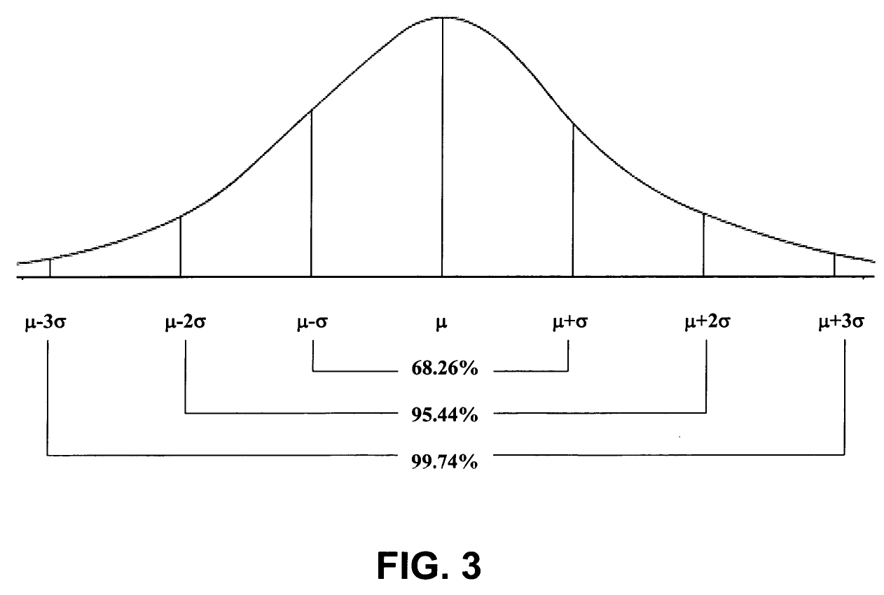

FIG. 3 shows the conversion between the cut off values and the anomaly distribution percentages based on the empirical results for the Z-Withins. Based on the empirical study approximately 6% of the anomaly scores are expected to have exceptional anomaly score values between 2 and 6. It should be noted that these expected anomaly percentages based on a real dataset are very similar to the percentages based on the simulation study displayed in FIG. 1. In specific, 6.7% of the scores are expected to be above the 2 cutoff and 13.4% of the scores are expected to be above the 2 and below the −2 cutoffs given this dataset. Similarly, when the sample sizes are 6 to 7, FIG. 1 shows 12.31% to 14.31% conversion for the above 2 and below −2 cutoffs.

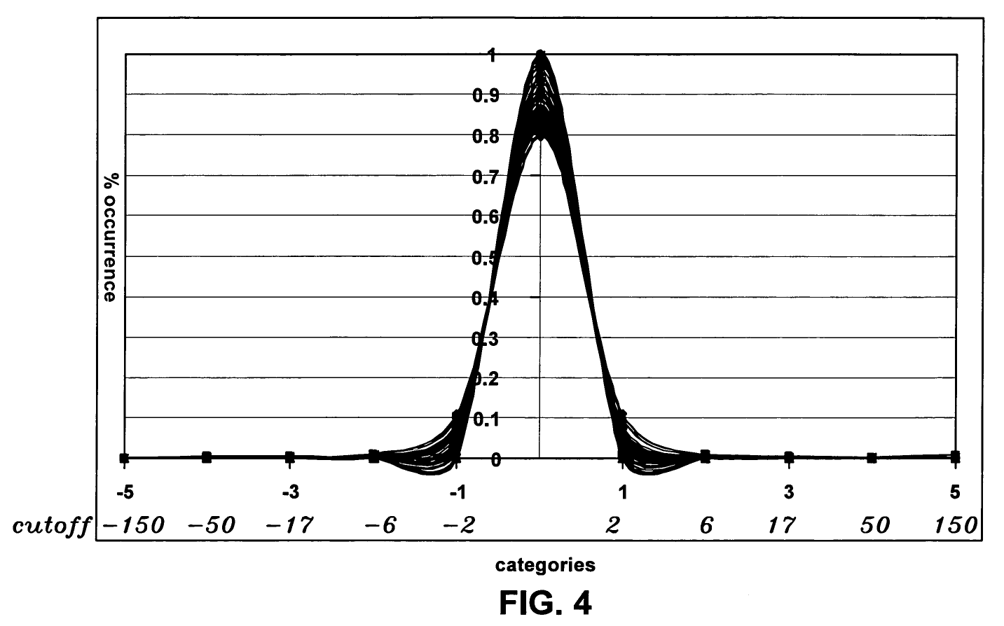

The above results validate the expected conversions for the exceptional anomaly score cutoffs given real life data from power generation equipment sensor data. A second set of analysis was performed to validate that the suggested cutoffs and corresponding percentages are valid not just for all Z-Withins across all tags but also within each tag where the sample size is relatively smaller compared to the overall data. Continuous Z-Within scores were converted into an 11-category ordinal score with the predefined 11 buckets. The distribution was then drawn of the ordinal score for each tag separately (see FIG. 4). As seen from the graph in FIG. 4, most of the tags have a similar shape distribution for the ordinal Z-Within Scores.

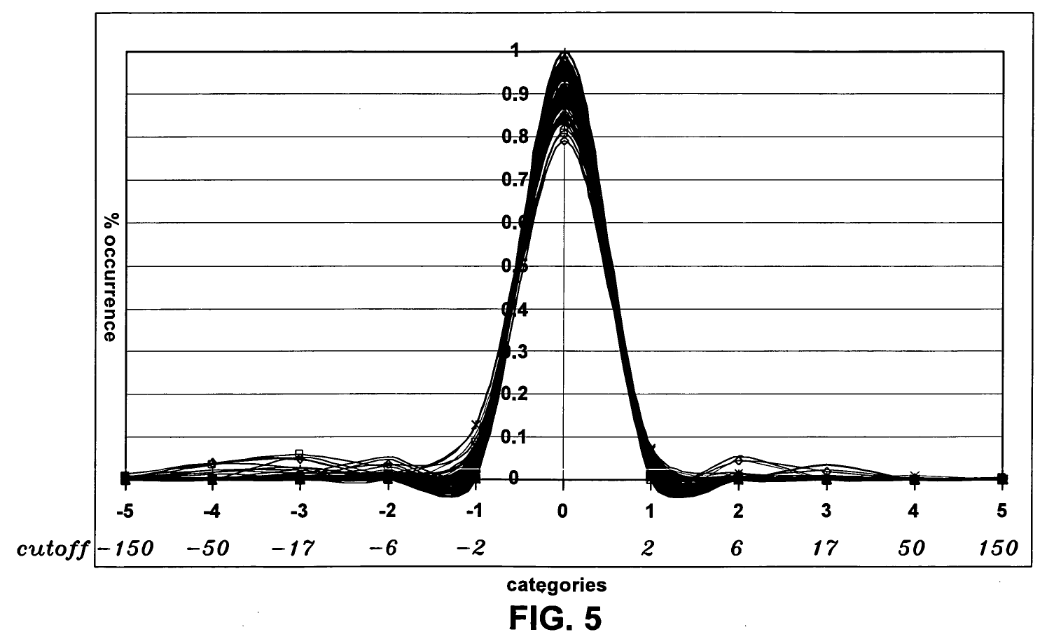

FIG. 5 illustrates the distributions on the ordinal Z-Between scores for each tag similar to FIG. 4. Although there are some tags with slightly different shapes for buckets 2, 3, −2, or −3, in general the shapes for the Z-Between scores are not too different than the shapes for the Z-Within scores. Thus, it is concluded that the same cutoff values across tags can be used for both Z-Within and Z-Between scores within this dataset. Moreover, the conversion anomaly percentages for the suggested cutoffs (i.e., 2, 6, 17, 50, 150, −2, −6, −17, −50, −150) can be determined either based on the empirical results (see FIG. 3) or based on the simulation study (see FIG. 1) since they suggest similar numbers.

Aggregating Various Anomalous Observations

Many equipment users (e.g., power plants, turbine operators, etc.) have an abundance of data for monitoring & diagnostics. More importantly, this data often exists in small time units (e.g., every second or every minute). Although data abundance is an advantage, its aggregation should be done effectively so that data storage and data monitoring do not become problematic and data still keeps its useful knowledge.

Although aggregation is highly desirable, for some tasks it poses a risk. Anomaly aggregation in and of itself is an oxymoron. All anomalies imply specificity and concentrating on each and every data point, whereas aggregation implies summarization via excluding the specifics and the anomalies. However, regardless of its contradicting nature, anomaly aggregation is needed since per-second or per-hour data can not be stored for many tags across many time periods and more importantly, for certain types of events, it may be too much information to monitor every second or even every hour. More specifically, most equipment users are interested in catching ‘acute’ versus ‘chronic’ anomalies for their machine units. Acute anomalies are the rarely happening, high magnitude anomalies. Chronic anomalies frequently happen across different units and time for a specific metric.

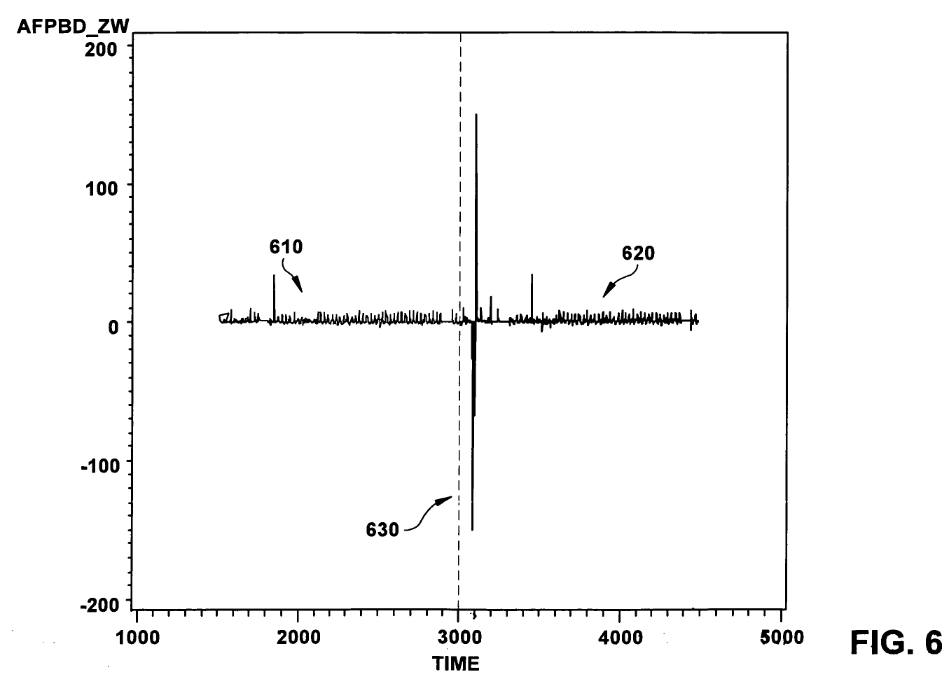

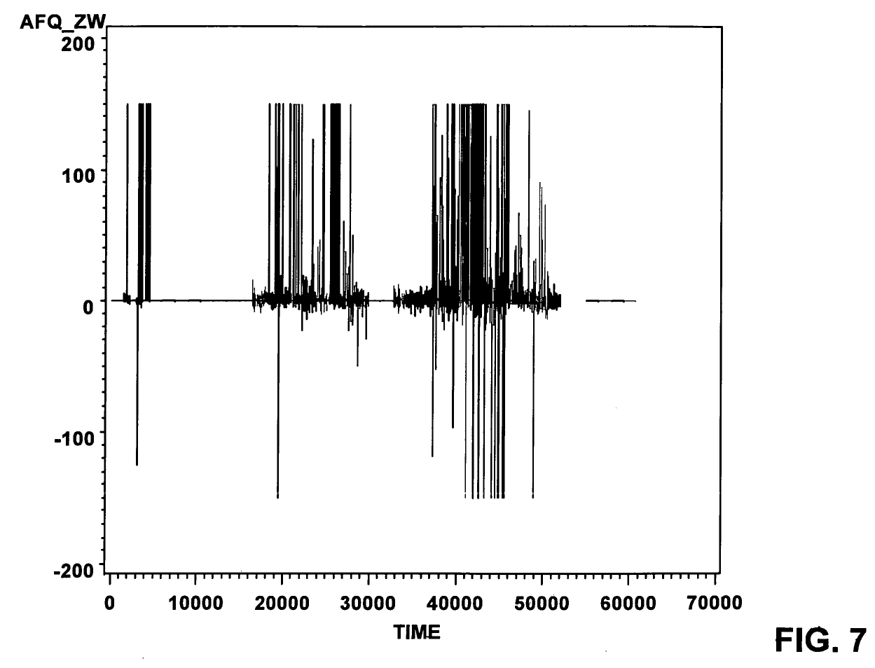

FIG. 6 illustrates two units' Z-Within measurements over time. The X-axis is the time for each unit. The vertical dotted line 630 separates the two units' data. The first unit's data is on the left side of dotted line 630 and is indicated by 610. The second unit's data is to the right of the dotted line 630 and is indicated by 620. As can be seen from the graph, the second unit (region 620) has two outliers that are below and above −100 and 100, respectively. Since the occurrence of these ranges is a rare happening for this metric and for these units, these two outliers are named as ‘acute’. The graph in FIG. 7, can be read similarly to the graph in FIG. 6, and demonstrates the concept of ‘chronic anomalies’. Chronic anomalies, which by definition are capture anomalies (i.e., above 2 or below −2 magnitudes on exceptional anomaly scores) that frequently happen across different units and time for a specific metric.

As mentioned before, there are many different ways to aggregate data. Statistics by definition contains aggregation. Demonstrating the data via a handful of numbers, e.g., mean, median, standard deviation, variance, etc., is the simplistic definition of ‘statistics’ or ‘analytics’. However, none of these long-existing methods provide a solution for anomaly aggregation. A daily average cannot consistently illustrate an hourly anomaly. Aggregation of f“exceptional anomaly scores” is a new method, as embodied by the present invention. Previously, monitoring hourly data was the only way to identify hourly anomalies. Data monitoring had to be done at the level of granularity in which the anomalies needed to be detected. In other words, it had to be done in the highest granularities, e.g., per second or per hour. At this granularity it is difficult to see longer-term trends or to effectively compare and contrast across units.

Two measures are described, according to embodiments of the present invention, which can be used to aggregate the exceptional anomaly scores: magnitude anomaly measure and frequency anomaly measure. Magnitude anomaly measure uses central tendency measures such as the average. Frequency anomaly measure uses ratios or percentages.

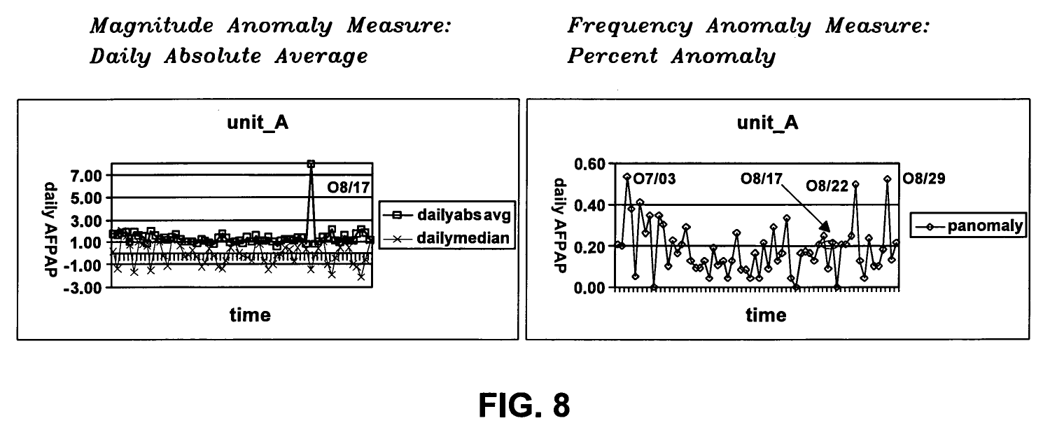

A magnitude anomaly measure can identify acute anomalies, and may use central tendency measures, such as the average. A daily absolute average (shown on the left of FIG. 8) is one example of a magnitude anomaly measure. An absolute average can illustrate whether there are one or more high magnitude anomalies in either negative or positive direction within a predetermined period of time (e.g., second, minute, hour, day, week, month or year). For example, a daily absolute average would illustrate whether there are one or more high magnitude anomalies in either negative or positive direction within a day.

A frequency anomaly measure can be used to identify chronic anomalies, and may use ratios or percentages. A daily percent anomaly (shown on the right on FIG. 8) is an example of a frequency anomaly measure. Daily percent anomaly would complement the daily absolute average in the sense that it could illustrate the number of anomalous hours within a day, or the number of anomalous days within a month. In general, the frequency anomaly measure can be used to illustrate the number of anomalous time periods (e.g., seconds, minutes, hours, etc.) within a larger time period (e.g., minutes, hours, days, etc.).

When these two scores (i.e., daily absolute average and daily percent anomaly) are used simultaneously, they would demonstrate days with anomalous hours as well as differentiating acute vs. chronic anomalies. Acute anomalies (rarely occurring) would have high daily absolute averages and low daily percent anomalies. Acute anomalies could be illustrated by one or two high magnitude anomalies. On the other hand, chronic anomalies (frequently occurring) would have low or high daily absolute averages and high daily percent anomalies. Chronic anomalies could be illustrated by a few to a series of anomalies within a day. However, chronic anomalies do not necessarily need to have high magnitudes of exceptional anomaly scores.

FIG. 8 shows an example on the use of the magnitude and frequency anomaly measures. The graph on the left of FIG. 8 shows a magnitude anomaly measure with a daily absolute average. The graph to the right shows a frequency anomaly measure with a percent anomaly. These magnitude and frequency anomaly scores can be calculated both for Z-Betweens and Z-Withins. Moreover, on each dimension both magnitude and frequency scores can be separately ranked across tags, time periods, and machine units. Then those ranks can turn into percentiles, providing a percentile on magnitude anomaly score vs. a percentile on the frequency anomaly score. In addition, these percentiles on each score can be combined via the ‘maximum’ function for Z-Betweens and Z-Withins separately. More specifically, a maximum percentile on either a Z-Between or Z-Within Anomaly Score would represent either an acute or a chronic anomaly or both.

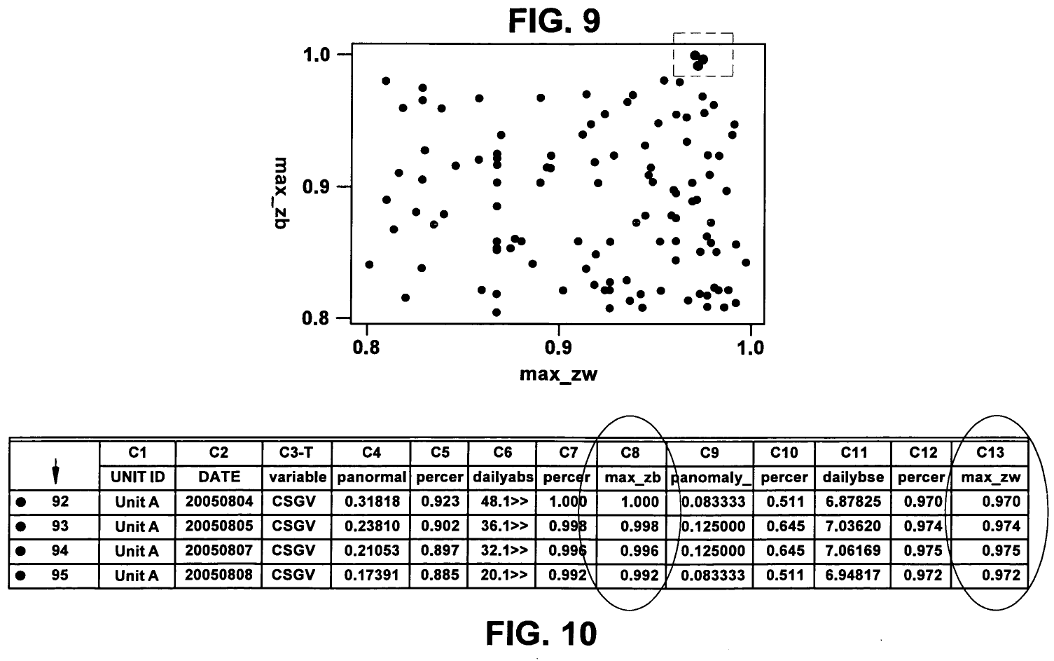

FIG. 9 illustrates a graph and a set of data on maximum percentile Z-Betweens and maximum percentile Z-Withins. For example, the dots in the dotted box at the upper right of the graph represent the same turbine on four consecutive days triggering anomalies with respect to the “CSGV” tag. The CSGV tag can be a metric relating to the IGV (inlet guide vane) angle. These four data points (corresponding to data entries 92, 93, 94, 95 in FIG. 10) are anomalous both with respect to the past and peers of the unit. If these four days are further investigated for this unit on the CSGV tag, it can be seen that many hours within those days have anomalies with respect to peers. On the other hand, hourly Z-Within anomalies are rare in number compared to hourly Z-Between anomalies, however they are high in magnitude. All of this conclusion can be read from the data table in FIG. 10 that contains the daily magnitude and frequency anomaly scores and daily percentiles for Z-Betweens and Z-Withins.

Creating Alerts And Creating Heatmaps

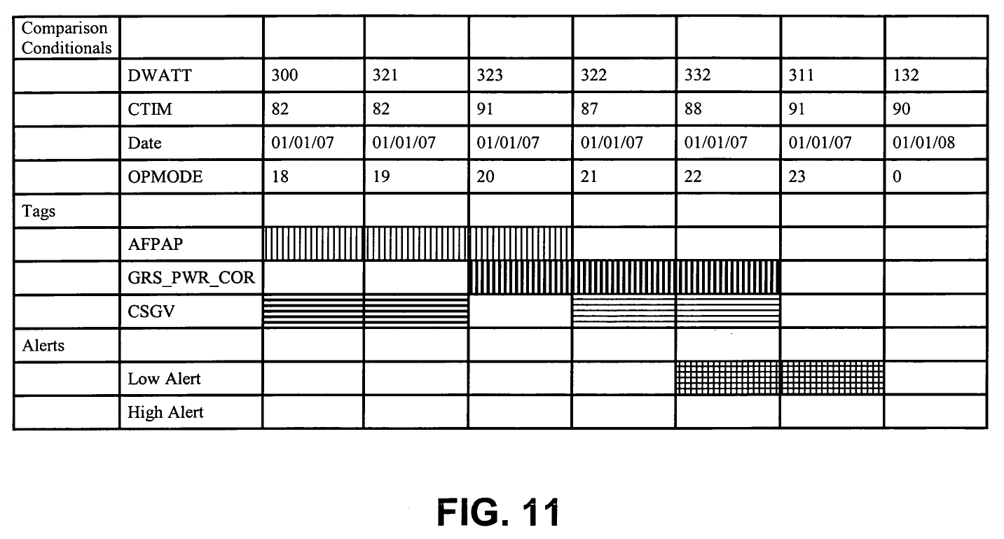

The anomaly detection process and heatmap tool can be implemented in software with two Java programs called the Calculation Engine and the Visualization Tool, according to one embodiment of the present invention. The Calculation Engine calculates exceptional anomaly scores, aggregates anomaly scores, updates an Oracle database, and sends alerts when rules are triggered. The Calculation Engine can be called periodically from a command-line batch process that runs every hour. The Visualization Tool displays anomaly scores in a heatmap (see FIG. 11) on request and allows users to create rules. The Visualization Tool could be run as a web application. These programs can be run on a Linux, Windows or other operating system based application processor.

An example command line call for the Calculation Engine is:

java -Xmx2700m -jar populate.jar—update t7 n

This instructs the Calculation Engine to perform the periodic update, utilize up to 7 or more simultaneous threads, and identify any new sensor data in the database prior to proceeding. The program begins by calculating rules for any new custom alerts and any new custom peers of machine units created by the users of the Visualization Tool. It then retrieves newly arrived raw sensor data from a server, stores the new data in the Oracle database, and calculates exceptional anomaly scores and custom alerts for the newly added data. It stores results of all these calculations in a database, enabling the Visualization Tool to display a heatmap of the exceptional anomaly scores and custom alerts. If the calculations trigger a custom alert with a rule that has a high possibility of detecting a machine deterioration event with lead time, the Calculation Engine can be configured to send warning signals to members of the Monitoring & Diagnostics team. Alerts could be audio and/or visual signals displayed by the team's computers/notebooks, or signals transmitted to the team's communications devices (e.g., mobile phones, pagers, PDA's, etc).

The Visualization Tool's primary use is to display heatmaps for specific machine units to members of the Monitoring & Diagnostics team. Users of the Visualization Tool can change the date range, change the peer group, and drill into time series graphs of individual tags' data. The Visualization Tool may utilize Java Server Pages for its presentation layer and user interface. The Java Server Pages are the views in MVC architecture and contain no business logic. The only requirements on the server and client machines are a Java compliant servlet container and a web browser, for this example embodiment.

The Visualization Tool also supports several other use cases. Users of the Visualization Tool can view peer heatmaps; find machines with similar alerts; create custom peer groups; create custom alerts; and view several kinds of reports. Peer heatmaps merge each machine's heatmap into a single heatmap with adjacent columns showing peer machines' heatmap cells at the same instant in time instead of showing the machine's own heatmap cells at earlier and later times. Users can change the date; drill into time series graphs comparing peers' data for specific tags, and drill through to machine heatmaps. On other pages, users can also specify custom alerts and search for machines that have triggered these alerts. Users can create, modify, and delete rules for custom alerts. Reports summarize information about monitored units, the latency of units' raw sensor data (which differs among units), and the accuracy of the alerts triggered so far.

For example, the anomaly detection techniques, as embodied by the present invention, were applied to a set of turbines for which a significant failure event occurred. The failure event was rare, occurring in only 10 turbines during the 4-month period for which historical sensor data was available. For each turbine that experienced the event (event units), up to 2 months of historical data was collected. For the purposes of comparison, 4 months of historical data for 200 turbines that did not experience the event (non-event units) was obtained.

A peer group was created for each event unit consisting of 6-8 other turbines of similar configuration operating within the same geographic region. The Z-Within and Z-Between exceptional anomaly scores were then calculated for the event and non-event units. The Z-Withins represented how different a unit was compared to past observations when the unit was operating under similar conditions as measured by operating mode, wattage output, and ambient temperature. The Z-Betweens represented how different a unit was compared to its peers when they were operating under similar conditions. These deviations were then visualized via a heatmap, as illustrated in FIG. 11.

The columns of the heatmap, shown in FIG. 11, represent time periods. The time periods could be days, hours, minutes, seconds or longer or shorter time periods. The rows represent metrics of interest, such as vibration and performance measures. For each metric, there can be two or more rows of colored cells, however, only one row is shown in FIG. 11 and the cells are shaded with various patterns for clarity. White cells can be considered normal or non-anomalous. The light vertical line filled cells in the AFPAP row could be considered as low negative values, while the heavy vertical line filled rows in the GRS_PWR_COR (corrected gross power) row could be considered as large negative values. The light horizontal lines in the CSGV row could be considered as low positive values, while the heavy horizontal lines in the same row could be considered high positive values. The low alert row has a cross-hatched pattern in specific cells. This is but one example of visually distinguishing between low, high and normal values, and many various patterns, colors and/or color intensities could be used.

The cells of the heatmap can display different colors or different shading or patterns to differentiate between different levels or magnitudes and/or directions/polarities of data. In two-row embodiments, the top row could represent the magnitude of the Z-Between exceptional anomaly scores whereas the bottom row could represent the magnitude of the Z-Within exceptional anomaly scores. If the anomaly score is negative (representing a value that is unusually low), the cell could be colored blue. Smaller negative values could be light blue and larger negative values could be dark blue. If the anomaly score is positive (representing a value that is unusually high), the cell could be colored orange. Smaller positive values could be light orange and larger positive values could be dark orange. The user can specify the magnitude required to achieve certain color intensities. There can be as many color levels displayed as desired, for example, instead of three color levels, 1, 2 or 4 or more color intensity levels could be displayed. In this example the cutoffs were determined by the sensitivity analysis.

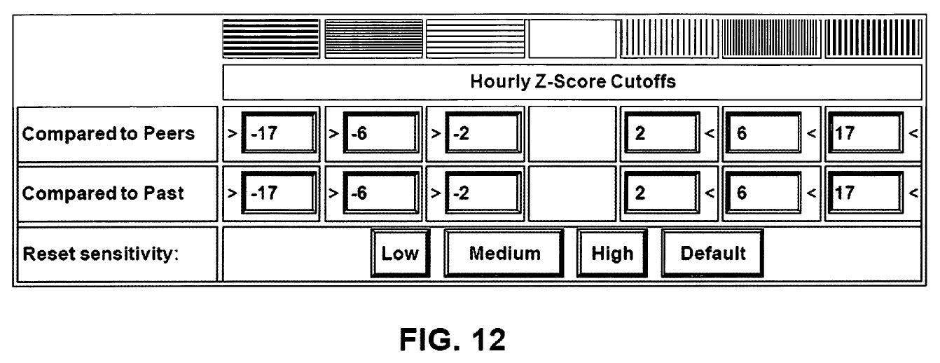

The heatmap shown in FIG. 12 provides a single snapshot of the entire system state for the last 24-hour period. The cells identify those metrics that are unusual when compared to the turbine's past or peers. The heatmap allows a member of the monitoring team to quickly view the system state and identify hot-spot sensor values. In the case of the failure event units, the heatmap shows that the turbine experienced a significant drop in many of the performance measures, such as GRS_PWR_COR (corrected gross power) at the same time it was experiencing significant increases in vibration (as measured by the BB and BR metrics). Inspection of event vs. non-event turbine heatmaps showed that this signature was present in 4 of the 10 event units for several hours prior to the event, but was not present in any of the non-event units. By visually inspecting the heatmap of event units versus non-event units, the monitoring team can develop rules that will act as warning signs of this failure condition. These rules can then be programmed into the system in the form of rule-based red flags. The system will then monitor turbines and signal or alert the monitoring team when these red flags are triggered.

The top row of the heatmap shown in FIG. 12 can display various patterns, colors and color intensities to visually distinguish between different ranges of values. In this example, large negative values can be indicated by heavy horizontal lines, medium negative values by medium horizontal lines and low negative values by light horizontal lines. Similarly, large positive values can be indicated by heavy vertical lines, medium positive values by medium vertical lines and low positive values by light vertical lines. In embodiments using color, the rectangles in the top row of the heatmap shown in FIG. 12 could display various colors and intensities. For example, the box filled with heavy horizontal lines could be replaced by a solid dark blue color, the box filled with medium horizontal lines could be replaced by a solid blue color, and the box filled with light horizontal lines could be replaced with a solid light blue color. The box filled with heavy vertical lines could be replaced by a solid dark orange color, the box filled with medium vertical lines could be replaced by a solid orange color, and the box filled with light vertical lines could be replaced with a solid light orange color. These are but a few examples of the many colors, patterns and intensities that can be used to distinguish between various anomalous values or scores.

While various embodiments are described herein, it will be appreciated from the specification that various combinations of elements, variations or improvements therein may be made, and are within the scope of the invention.

What is claimed is:

1. A method for identifying an anomalous value, the method comprising:
obtaining operational data from at least one machine;
calculating at least one exceptional anomaly score from said operational data;
aggregating said at least one exceptional anomaly score.

2. The method as defined in claim 1, further comprising the step of:
calculating at least one magnitude anomaly measure, said at least one magnitude anomaly measure identifying the average value of said operational data or said at least one exceptional anomaly score over a predetermined period of time.

3. The method as defined in claim 2, wherein said predetermined period of time is chosen from the group comprising of:
seconds, minutes, hours, days, weeks, months and years.

4. The method as defined in claim 1, further comprising the step of:
calculating at least one frequency anomaly measure, said at least one frequency anomaly measure indicating any predetermined period of time having anomalous values.

5. The method as defined in claim 4, wherein said predetermined period of time is chosen from the group comprising of:
seconds, minutes, hours, days, weeks, months and years.

6. The method as defined in claim 3, wherein said aggregating step further comprises:
calculating at least one frequency anomaly measure, said at least one frequency anomaly measure identifying the number of predetermined periods of time having anomalous values;
said predetermined period of time chosen from the group comprising, at least one of, seconds, minutes, hours, days, weeks, months and years.

7. The method as defined in claim 1, wherein said at least one machine is a turbomachine selected from the group comprising:
a compressor, a gas turbine, a hydroelectric turbine, a steam turbine, a wind turbine, an engine, a genset, a locomotive and a generator.

8. The method as defined in claim 7, wherein the step of obtaining operational data further comprises:
obtaining operational data from a plurality of machines, each of said machines being similar in, at least one of, configuration, capacity, size, output and geographic location.

9. The method as defined in claim 6, further comprising:
combining said at least one magnitude anomaly measure and said at least one frequency anomaly measure in, at least one of, a graphical or tabular form, said combining indicating if any acute or chronic anomalies are present in said at least one exceptional anomaly score.

10. The method as defined in claim 9, wherein acute anomalies are indicated by, at least one of:
high values of said at least one magnitude anomaly measure, low values of said at least one frequency anomaly measure, and rarely occurring anomalous values.

11. The method as defined in claim 9, wherein chronic anomalies are indicated by:
low or high values of said at least one magnitude anomaly measure, and high values of said at least one frequency anomaly measure.

12. A method for aggregating anomalous values, the method comprising:
obtaining operational data from at least one machine;
calculating at least one exceptional anomaly score from said operational data;
aggregating said at least one exceptional anomaly score, by
calculating at least one magnitude anomaly measure, said at least one magnitude anomaly measure identifying the average value of said operational data or said at least one exceptional anomaly score over a predetermined period of time, and
calculating at least one frequency anomaly measure, said at least one frequency anomaly measure indicating any predetermined period of time having anomalous values.

13. The method as defined in claim 12, wherein said predetermined period of time is chosen from, at least one of, the group comprising:
seconds, minutes, hours, days, weeks, months and years.

14. The method as defined in claim 13, wherein said at least one machine is a turbomachine selected from the group comprising:
a compressor, a gas turbine, a hydroelectric turbine, a steam turbine, a wind turbine, an engine, a genset, a locomotive and a generator.

15. The method as defined in claim 14, wherein the step of obtaining operational data further comprises:
obtaining operational data from a plurality of machines, each of said machines being similar in, at least one of, configuration, capacity, size, output and geographic location.

16. The method as defined in claim 6, further comprising:
combining said at least one magnitude anomaly measure and said at least one frequency anomaly measure in, at least one of, a graphical or tabular form, said combining indicating if any acute or chronic anomalies are present in said at least one exceptional anomaly score.

17. The method as defined in claim 16, wherein acute anomalies are indicated by, at least one of:
high values of said at least one magnitude anomaly measure, low values of said at least one frequency anomaly measure, and rarely occurring anomalous values.

18. The method as defined in claim 16, wherein chronic anomalies are indicated by:
low or high values of said at least one magnitude anomaly measure, and high values of said at least one frequency anomaly measure.
